(19) United States
(12) Patent Application Publication
(10) Pub. No.: US 2016/0098712 A1
(43) Pub. Date: Apr. 7, 2016

(54) ONLINE TRANSACTION VERIFICATION SYSTEM

(71) Applicant: Mohammad Karaki, Boca Raton, FL (US)

(72) Inventor: Mohammad Karaki, Boca Raton, FL (US)

(21) Appl. No.: 14/508,706

(22) Filed: Oct. 7, 2014

(51) Int. Cl. G06Q 20/40

(52) U.S. Cl. CPC G06Q 20/40

(57) ABSTRACT

According to one embodiment, an online transaction verification system includes one or more processors configured to receive an indication that a card user is attempting to perform an online transaction using payment card information. The processors are also configured to transmit a challenge code configured to interrogate a card user identification device for a first verification code, and to receive the first verification code. The first verification code is selected, by the card user identification device, from a plurality of verification codes, and according to a predefined manner. The processors are further configured to select a first comparison code according to the predefined manner, and compare the first comparison code to the first verification code. The processors are further configured to, following a determination that the first comparison code matches the first verification code, transmit a verification signal configured to indicate that the online transaction has been verified.

### TECHNICAL FIELD

This disclosure relates generally to the field of transactions and more specifically to an online transaction verification system.

### BACKGROUND

In order to conduct an online transaction with a merchant, a customer typically pays for goods or services received from the merchant using online payment accounts (such as PayPal), electronic funds (such as bitcoins), or credit/debit cards. Payments using credit/debit cards for an online transaction typically involve the customer entering their credit/debit card information into a secured web browser for transmittal to the merchant for processing. Such online transactions, however, may be susceptible to fraud. Furthermore, typical techniques for preventing fraud in online transactions with credit/debit cards may be deficient.

### SUMMARY

According to one embodiment, an online transaction verification system includes one or more memory units and one or more processors. The memory units are configured to store a plurality of comparison codes. The processors are configured to receive an indication that a card user is attempting to perform an online transaction using payment card information and a transaction device. The transaction device is communicatively coupled to a merchant device with which the card user is attempting to perform the online transaction. The processors are also configured to, following reception of the indication, transmit a challenge code configured to interrogate a card user identification device for a first verification code. The challenge code is received by a card user verification device communicatively coupled to the transaction device, and the challenge code is re-transmitted from the card user verification device to the card user identification device. The processors are further configured to, following transmittal of the challenge code, receive the first verification code from the card user identification device. The first verification code is selected, by the card user identification device, from a plurality of verification codes stored by the card user identification device, and according to a predefined manner. The processors are further configured to select a first comparison code from a plurality of comparison codes according to the predefined manner, and compare the first comparison code to the first verification code from the card user identification device. The processors are further configured to, following a determination that the first comparison code matches the first verification code, transmit a verification signal configured to indicate that the online transaction has been verified.

Certain embodiments of the disclosure may provide one or more technical advantages. For example, in order for an online transaction to be approved, a verification entity device may compare a comparison code selected by the verification entity device with a verification code selected by a card user identification device. As such, even if a person (or a device) is able to steal or copy a card user's payment card information or the payment card, the person may be unable to conduct one or more online transactions using the payment card information (or the payment card) because the person may not also have the card user identification device, the verification code stored and selected by the card user identification device, and/or the card user verification device that may allow the card user identification device to communicate the verification code to the verification entity device. As another example, the card user identification device may select a particular verification code for an online transaction by sequentially rotating through each of the verification codes stored by the card user identification device. As such, the same code may be re-used as the verification code at a later date and/or time, and the card user identification device may not need to receive new verification codes from the verification entity device when all of the verification codes have already been used. As a further example, a verification code stored in the card user identification device may be selected and/or communicated for receipt by the verification entity device without intervention by the card user. As such, the verification process may be easier for the card user. As a further example, the card user verification device may easily install onto the transaction device, such as by the card user connecting the card user verification device to a universal serial bus port of the transaction device. As such, the card user may be able to perform verified online transactions without any complicated installation procedures.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE FIGURES

For a more complete understanding of the present disclosure and its features and advantages, reference is now made to the following description, taken in conjunction with the accompanying drawings, in which:

FIG. 1 illustrates an example online transaction verification system that verifies online transactions between card users and merchants; and

FIG. 2 illustrates an example selection of verification codes and comparison codes of FIG. 1.

### DETAILED DESCRIPTION

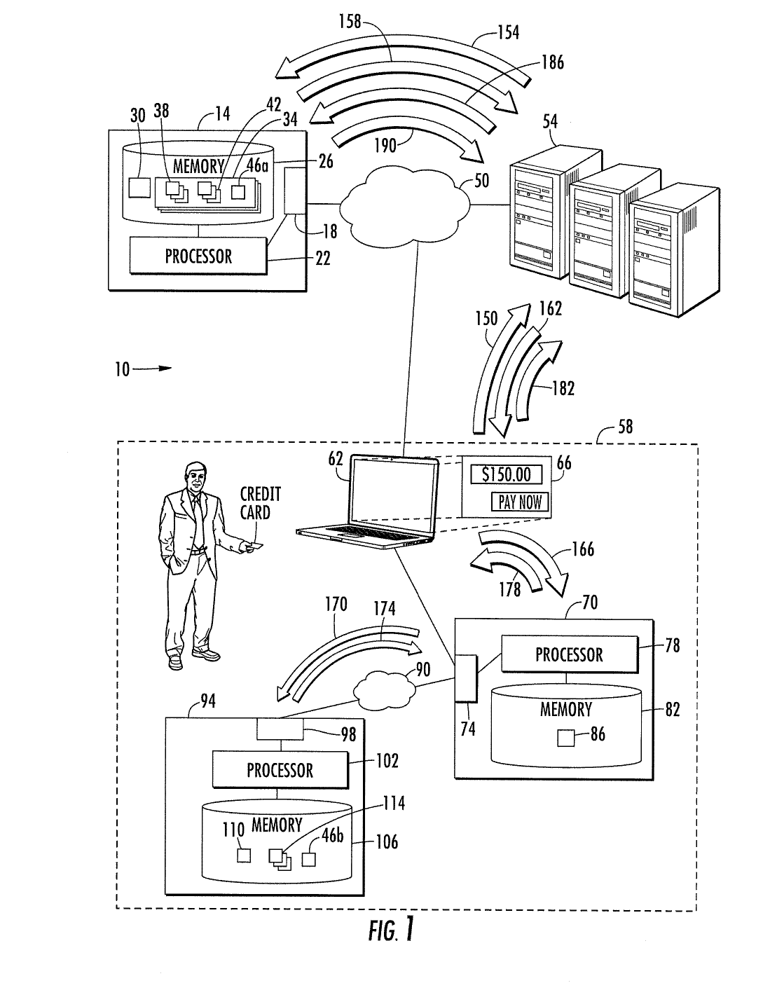

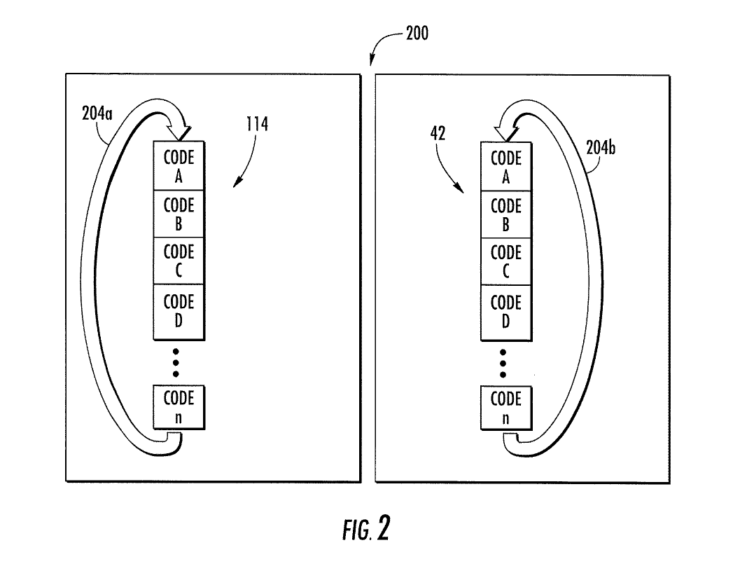

Embodiments of the present disclosure are best understood by referring to FIGS. 1-2 of the drawings, like numerals being used for like and corresponding parts of the various drawings.

FIG. 1 illustrates an example online transaction verification system 10 that verifies online transactions between card users and merchants. System 10 includes a verification entity device 14 that stores comparison codes 42, and further includes a card user identification device 94 that stores verification codes 114. When a card user attempts to perform an online transaction using a payment card (e.g., a credit card) and a transaction device 62 (e.g., a laptop computer or a mobile phone), the verification entity device 14 may compare a comparison code 42 (which is selected in a predefined manner by the verification entity device 14) with a verification code 114 (which is selected in the same predefined manner by the card user identification device 94 and then communicated to the verification entity device 14) in order to determine whether to approve the online transaction. In particular embodiments, this may provide additional protection against fraud. Furthermore, system 10 also includes a card user verification device 70 that is communicatively coupled to the card user identification device 94 and also communicatively coupled to the transaction device 62 (such as connected to the universal serial bus port of the transaction device 62). In particular embodiments, this may provide an easily installed card user verification device 70 that allows communication of verification codes 114 to the verification entity device 14, thereby allowing system 10 to provide additional protection against fraud in an online transaction.

A verification entity represents an entity that communicates with customers and/or merchants in order to verify online transactions between the customers and merchants. For example, a verification entity may be a financial institution, such as a credit card company, credit card servicer, debit card company, debit card servicer, bank, any other institution that communicates with customers and/or merchants in order to facilitate online transactions between the customers and merchants, or any combination of the preceding. In such an example, the verification entity verifies online transactions for customers that have a credit card account, a savings account, a debit card account, a checking account, any other account associated with the financial institution (or a merchant), or any combination of the preceding. As another example, the verification entity may be a third party entity, such as a clearinghouse, payment processing institution, any other entity that may communicate with a financial institution in order to assist in facilitating online transactions between the customers and merchants, or any combination of the preceding. In such an example, the verification entity verifies online transactions for customers (and/or merchants) associated with the financial institution. As a further example, a verification entity may be a combination of a financial institution and a third party entity.

A merchant represents an entity in any suitable industry that conducts an online transaction with a customer. The merchant may include a retailer, a wholesaler, a service company, or any other suitable entity that has customers and conducts online transactions with the customers. The merchant interacts with the verification entity associated with a customer in order to facilitate each online transaction.

An online transaction represents a transaction made between a customer and merchant over an electronic (or online) communication network, and may include receiving payment from the customer for goods or services provided by the merchant (or crediting a refund to the customer). An example of an online transaction may be a customer purchasing goods from the merchant over the Internet using a web browser displayed on a computing device (such as a laptop computer).

A payment card represents a credit card, a debit card, a check, a coupon linked to an account, a gift card linked to an account, a money order, a promissory note, or any other manner of non-cash payment. A card user (i.e., a customer using the payment card) may use the payment card in order to pay for goods or services from a merchant. For example, for an online transaction, the card user may enter payment card information into a merchant's web page in order to pay for goods or services from the merchant. Payment card information may represent any information associated with the payment card, the card user, and/or an account of the card user. For example, payment card information may include the payment card number, the payment card expiration date, the payment card verification code, the billing address associated with the payment card, the card user, and/or the account of the card user, the shipping address associated with the card user, any other information that may be used to process an online transaction, or any combination of the preceding.

In order to conduct an online transaction with a merchant, a customer typically pays for goods or services received from the merchant using online payment accounts (such as PayPal), electronic funds (such as bitcoins), or credit/debit cards. Payments using credit/debit cards for an online transaction typically involve the customer entering their credit/debit card information into a secured web browser for transmittal to the merchant for processing. Such online transactions, however, may be susceptible to fraud. Furthermore, typical techniques for preventing fraud in online transactions with credit/debit cards may be deficient. As such, in particular embodiments, system 10 of FIG. 1 may verify online transactions between card users and merchants in a manner that provide various advantages. For example, in order for an online transaction to be approved, the verification entity device 14 may compare a comparison code 42 selected by the verification entity device 14 with a verification code 114 selected by a card user identification device 94 carried by the card user. In such an example, even if a person (or a device) is able to steal or copy a card user's payment card information or the payment card, the person may be unable to conduct one or more online transactions using the payment card information (or the payment card) because the person may not also have the card user identification device 94 and/or the card user verification device 70 that may allow the card user identification device 94 to communicate with the verification entity device 14. Furthermore, even if a person (or a device) is also able to attempt to provide a code to the verification entity device 14 (using a fraudulent device, for example), the provided code may not match the comparison code 42 utilized by the verification entity device 14 because the fraudulent device may not have access to verification codes 114 or a verification management application 46b that results in a verification code 114 being selected in a predefined manner.

As another example, the card user identification device 94 may select a particular verification code 114 for an online transaction by sequentially rotating through each of the verification codes 114 stored at the card user identification device 94. In such an example, this may allow the same code to be re-used as the verification code 114 at a later date and/or time from the original use of the code. Furthermore, this may prevent the card user identification device 94 from needing to receive new verification codes 114 from verification entity device 14 (or some other device associated with the verification entity) when all of the verification codes 114 have already been used. As a further example, a verification code 114 stored in the card user identification device 94 may be selected and/or communicated for receipt by the verification entity device 14 without intervention by the card user. In such an example, the verification process may be easier for the card user because the card user may not need to perform any type of action to assist in the verification of the online transaction, other than the card user actually carrying the card user identification device 94 with them when performing the online transaction (such as carrying the card user identification device 94 in the card user's purse or attached to the card user's keys) and/or other than the card user performing the online transaction with a transaction device 62 (and/or card user verification device 70) that is within communication range to the card user identification device 94 (such as within Bluetooth range, WiFi range, radio frequency identification range, infrared range, or any other suitable range). As a further example, the card user verification device 70 may easily install onto (or otherwise communicate with) the transaction device 62, such as by the card user connecting the card user verification device 70 to a universal serial bus port (or other connection) of the transaction device 62. As such, the card user may be able to perform verified online transactions without any complicated installation procedures. Therefore, system 10 may verify online transactions between card users and merchants in a manner that is advantageous.

Verification entity device 14 represents any suitable components that verify online transactions between card users and merchants. Verification entity device 14 may include a network server, any suitable remote server, a mainframe, a host computer, a workstation, a web server, a personal computer, a file server, or any other suitable device for verifying online transactions between card users and merchants. The functions of verification entity device 14 may be performed by any suitable combination of one or more servers or other components at one or more locations. In the embodiment where the verification entity device 14 is a server, the server may be a private server, and the server may be a virtual or physical server. The server may include one or more servers at the same or remote locations. Also, verification entity device 14 may include any suitable component that functions as a server. As illustrated, verification entity device 14 includes a network interface 18, a processor 22, and a memory unit 26.

Network interface 18 represents any suitable device operable to receive information from network 50, transmit information through network 50, perform processing of information, communicate to other devices, or any combination of the preceding. For example, network interface 18 receives transaction information associated with an online transaction between a card user and a merchant. As another example, network interface 18 communicates a challenge code 38 for receipt by a card user identification device 94. Network interface 18 represents any port or connection, real or virtual, including any suitable hardware and/or software, including protocol conversion and data processing capabilities, to communicate through a local area network (LAN), a metropolitan area network (MAN), a wide area network (WAN), or other communication system that allows verification entity device 14 to exchange information with network 50, merchant device 54, card user environment 58, transaction device 62, card user verification device 70, network 90, card user identification device 94, or other components of system 10.

Processor 22 communicatively couples to network interface 18 and memory unit 26, and controls the operation and administration of verification entity device 14 by processing information received from network interface 18 and memory unit 26. Processor 22 includes any hardware and/or software that operates to control and process information. For example, processor 22 executes verification entity device management application 30 to control the operation of verification entity device 14. Processor 22 may be a programmable logic device, a microcontroller, a microprocessor, any suitable processing device, or any combination of the preceding.

Memory unit 26 stores, either permanently or temporarily, data, operational software, or other information for processor 22. Memory unit 26 includes any one or a combination of volatile or non-volatile local or remote devices suitable for storing information. For example, memory unit 26 may include random access memory (RAM), read only memory (ROM), magnetic storage devices, optical storage devices, any other suitable information storage device, or any combination of the preceding. Additionally, memory unit 26 may be an encrypted storage device (or a storage device secured in any suitable manner), providing protection against fraudulent attempts to access the information stored in memory unit 26. While illustrated as including particular information modules, memory unit 26 may include any suitable information for use in the operation of verification entity device 14.

As illustrated, memory unit 26 includes verification entity device management application 30 and accounts 34. Verification entity device management application 30 represents any suitable set of instructions, logic, or code embodied in a computer-readable storage medium and operable to facilitate the operation of verification entity device 14. Accounts 34 represent any information regarding personal, commercial, and/or corporate accounts handled by verification entity device 14 with regard to one or more payment cards. For example, accounts 34 includes account numbers, nicknames for accounts, account identifiers associated with an account, balance information of an account (and/or a payment card linked to the account), limits of an account (and/or a payment card linked to the account), disclaimers associated with an account, card user preferences, data associated with one or more online transactions performed (or in the process of being performed) by a card user, any other suitable data, or any combination of the preceding. Account 34 for each different card user (or for each account that includes multiple authorized card users) may include challenge codes 38, comparison codes 42, and verification management application 46a.

Challenge codes 38 represent any code that may be used to interrogate card user identification device 94 for a verification code 114. Examples of challenge codes 38 are discussed in further detail below. Comparison codes 42 represent any code that may be compared to a verification code 114 in order to verify an online transaction. Examples of comparison codes 42 are discussed in further detail below. Verification management application 46a represents any suitable set of instructions, logic, or code embodied in a computer-readable storage medium and operable to provide a predefined manner of selecting comparison codes 42, verification codes 114, and/or verifying an online transaction using comparison codes 42 and verification codes 114. Examples of verification management application 46a are discussed in further detail below.

Network 50 represents any suitable network operable to facilitate communication between the components of system 10, such as verification entity device 14, merchant device 54, card user environment 58, transaction device 62, card user verification device 70, network 90, and card user identification device 94. Network 50 may include any interconnecting system capable of transmitting audio, video, signals, data, messages, or any combination of the preceding. Network 50 may include all or a portion of a public switched telephone network (PSTN), a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the components.

Merchant device 54 represents any suitable components that communicate with a transaction device 62 in order to allow a card user to perform (or attempt to perform) an online transaction with a merchant. Merchant device 54 may include a network server, any suitable remote server, a mainframe, a host computer, a workstation, a web server, a personal computer, a file server, or any other suitable device for communicating with the transaction device 62 in order to allow a card user to perform (or attempt to perform) an online transaction with a merchant. The functions of merchant device 54 may be performed by any suitable combination ner, the first comparison code is selected, by the one or more processors, by sequentially rotating through the plurality of cor, the server may be a private server, and the server may be a virtual or physical server. The server may include one or more servers at the same or remote locations. Also, merchant device 54 may include any suitable component that functions as a server.

Merchant device 54 may store any information that may assist in allowing a card user to perform (or attempt to perform) an online transaction with a merchant. For example, merchant device 54 may store web page information (such information and/or files that may be utilized by a web browser to create and/or display a web page), online transaction information (such as the number and type of goods or services purchased, payment card information, the card user's shipping information, etc.), online transaction processing information (such as encryption or security information that may allow the payment card information entered by the card user to be encrypted or otherwise secured), any other information that may assist in allowing a card user to perform (or attempt to perform) an online transaction with a merchant, or any combination of the preceding. Additionally, merchant device 54 may further communicate with verification entity device 14 in order to process an online transaction between a card user and a merchant.

Merchant device 54 may be associated with a merchant. For example, a particular merchant may be a retail chain that sells goods to customers. This merchant may offer to sell their goods through an electronic (or online) connection network (such as the Internet) using a web page accessible by a web browser. In such an example, merchant device 54 may store the information utilized by a web browser to create and display the merchant's web page. Merchant device 54 may be owned by the merchant. For example, the merchant may own one or more merchant devices 54 in order to host the merchant's web page information. Furthermore, merchant device 54 (or all or a portion of the storage and/or processing capabilities of merchant device 54) may be temporarily purchased by the merchant, rented by the merchant, or otherwise obtained by the merchant.

Card user environment 58 represents any suitable components that allow card users to perform online transactions with merchants. As illustrated, card user environment 58 includes transaction device 62, card user verification device 70, network 90, and card user identification device 94. Transaction device 62 represents any suitable components that communicate with merchant device 14 in order to allow a card user to perform (or attempt to perform) an online transaction between a card user and a merchant. Transaction device 62 may be a personal computer, a workstation, a laptop, a mobile telephone (such as a Smartphone, or any other wireless, cellular, cordless, or satellite telephone), an electronic notebook, a personal digital assistant, any other device (wireless, wireline, or otherwise) capable of receiving, processing, storing, and/or communicating information with other components of system 10 in order to allow a card user to perform (or attempt to perform) an online transaction between a card user and a merchant, or any combination of the preceding. Transaction device 62 may include a user interface, such as a display, a microphone, keypad, or other appropriate terminal equipment usable by a card user.

As illustrated, in order to allow a card user to perform (or attempt to perform) an online transaction between a card user and a merchant, transaction device 62 may generate and display merchant interface 66. Merchant interface 66 represents any interface between transaction device 62 and merchant device 54 that allows a card user to perform (or attempt to perform) an online transaction with a merchant. For example, merchant interface 66 may be a web page, a graphical user interface, a text-based interface, an application (such as a mobile phone application) that allows a card user to perform (or attempt to perform) an online transaction with a merchant, any other interface that allows a card user to perform (or attempt to perform) an online transaction with a merchant, or any combination of the preceding. As illustrated, merchant interface 66 may be a web page associated with the merchant. The card user may access the web page by entering the web page's uniform resource locator (URL) into a web browser (such as Firefox, Internet Explorer, Google Chrome, Opera, or Safari). The web browser may access the web page's information (stored on merchant device 54) and use the accessed information to render the web page for display to the card user on transaction device 62. The card user may then use the web page to browse through one or more goods or services sold by the merchant, select one or more goods or services for purchase, enter payment card information for purchasing the goods or services, and submit the purchase to merchant device 54.

In addition to communicating with merchant device 54 in order to allow a card user to perform (or attempt to perform) an online transaction between a card user and a merchant, transaction device 62 may further communicate with card user verification device 70 in order to assist in the verification of online transactions between card users and merchants. Transaction device 62 may communicate with the card user verification device 70 in any suitable manner. For example, transaction device 62 may include (or be coupled to) one or more interfaces, connections, or ports (such as a serial port, a parallel port, a universal serial bus (USB) port, or any other communication port) that may communicatively couple transaction device 62 to the card user verification device 70. In such an example, the card user verification device 70 may be plugged into the interface, connection, or port (such as the USB port), allowing the transaction device 62 to communicate with the card user verification device 70. As another example, transaction device 62 may include a network interface similar to network interface 18 (discussed above). The network interface may be any port or connection, real or virtual, including any suitable hardware and/or software, including protocol conversion and data processing capabilities, to communicate through a LAN, a MAN, a WAN, or other communication system that allows transaction device 62 to exchange information with card user verification device 70. In such an example, transaction device 62 may be communicatively coupled to card user verification device 70 by a network similar to network 50 (discussed above).

Card user verification device 70 represents any suitable components that communicate with verification entity device 14 and card user identification device 94 in order to assist in the verification of online transactions between card users and merchants. Card user verification device 70 may be a personal computer, a workstation, a laptop, a mobile telephone (such as a Smartphone, or any other wireless, cellular, cordless, or satellite telephone), an electronic notebook, a personal digital assistant, a transceiver node, a radio frequency transceiver, a smart card reader, a wired identification tag transceiver, a wireless identification tag transceiver, any other device (wireless, wireline, or otherwise) capable of receiving, processing, storing, and/or communicating information with other components of system 10, or any combination of the preceding. Card user verification device 70 may act as an intermediary between verification entity device 14 and card user identification device 94. As an example, verification entity device 14 may communicate a challenge code 38 for receipt by the card user identification device 94. In such an example, card user verification device 70 may receive the challenge code 38 (prior to the card user identification device 94 receiving the challenge code 38) and may re-communicate the challenge code 38 to the card user identification device 94. Additionally, the card user identification device 94 may communication a verification code 114 for receipt by the verification entity device 14. In such an example, the card user verification device 70 may receive the verification code 114 (prior to the verification entity device 14 receiving the verification code 114) and may re-communicate the verification code 114 to the verification entity device 14.

Card user verification device 70 may be associated with a card user. For example, card user verification device 70 may be carried by the user (such as in the card user's pocket or purse), stored (or otherwise located) in the card user's office or residence, coupled to the transaction device 62 of the card user (such as connected to the USB port of the transaction device 62), any other manner of association with the card user, or any combination of the preceding. In such an example, the card user verification device 70 may assist in the verification of online transactions between card users and merchants, no matter where the card user is located. Furthermore, card user verification device 70 may include a user interface, such as a display, a microphone, keypad, or other appropriate terminal equipment usable by a card user.

As illustrated, card user verification device 70 includes a network interface 74, a processor 78, and a memory unit 82. Network interface 74 represents any suitable device operable to receive information from network 90 and/or network 50, transmit information through network 90 and/or network 50, perform processing of information, communicate to other devices, or any combination of the preceding. For example, network interface 74 receives a challenge code 38 from the verification entity device 14 and re-communicates the challenge code 38 to the card user identification device 94. As another example, network interface 74 receives a verification code 114 from the card user identification device 94 and re-communicates the verification code 114 for receipt by the verification entity device 14. Network interface 74 represents any port or connection, real or virtual, including any suitable hardware and/or software, including protocol conversion and data processing capabilities, to communicate through a LAN, a MAN, a WAN, or other communication system that allows network interface 74 to exchange information with verification entity device 14, network 50, merchant device 54, card user environment 58, transaction device 62, network 90, card user identification device 94, or other components of system 10. As an example, network interface 74 may be (or may further include) a radio frequency transceiver (such as a radio frequency identification transceiver, a Bluetooth transceiver, a WiFi transceiver, etc.) for communicating radio frequencies to and from the card user identification device 94. As another example, network interface 74 may be (or may further include) a speaker/microphone for communicating audio signals (such as audio tones) to and from the card user identification device 94. As a further example, network interface 74 may be (or may further include) a display screen for capturing images (such as a quick response (QR) code) generated and displayed on the card user identification device 94, or for generating and displaying images (such as a QR code) for capture by the card user identification device 94.

Processor 78 communicatively couples to network interface 74 and memory unit 82, and controls the operation and administration of card user verification device 70 by processing information received from network interface 74 and memory unit 82. Processor 78 includes any hardware and/or software that operates to control and process information. For example, processor 78 executes card user verification device management application 86 to control the operation of card user verification device 70. Processor 78 may be a programmable logic device, a microcontroller, a microprocessor, any suitable processing device, or any combination of the preceding.

Memory unit 82 stores, either permanently or temporarily, data, operational software, or other information for processor 78. Memory unit 82 includes any one or a combination of volatile or non-volatile local or remote devices suitable for storing information. For example, memory unit 82 may include RAM, ROM, magnetic storage devices, optical storage devices, any other suitable information storage device, or any combination of the preceding. Additionally, memory unit 82 may be an encrypted storage device (or a storage device secured in any suitable manner), providing protection against fraudulent attempts to access the information stored in memory unit 82. While illustrated as including particular information modules, memory unit 82 may include any suitable information for use in the operation of card user verification device 70. As illustrated, memory unit 82 includes card user verification device management application 86. Card user verification device management application 86 represents any suitable set of instructions, logic, or code embodied in a computer-readable storage medium and operable to facilitate the operation of card user verification device 70.

Although card user verification device 70 is illustrated as a separate device from transaction device 62, card user verification device 70 may the same device as transaction device 62. In such an example, a single device may be used to communicate with merchant device 54 in order to allow a card user to perform (or attempt to perform) an online transaction between a card user and a merchant, and also communicate with card user identification device 94 in order to assist in the verification of online transactions between card users and merchants.

Network 90 represents any suitable network operable to facilitate communication between the components of system 10, such as card user verification device 70 and card user identification device 94. Network 90 may include any interconnecting system capable of transmitting audio, video, signals, data, messages, or any combination of the preceding. Network 90 may include all or a portion of a PSTN, a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the components. Furthermore, network 90 may be the same type of network as network 50, or network 90 may be a different type of network than network 50. For example, both network 90 and network 50 may be a combination of wireless and wireline networks. As another example, network 90 may be only a wireless network (such as only a Bluetooth network, a WiFi network, a radio frequency identification network, or an infrared network), while network 50 may be a combination of wireless and wireline networks. Additionally, although network 90 and network 50 are illustrated as separate networks, network 90 and network 50 may be the same network. In such an example, a single network may communicate a challenge code 38 from verification entity device 14 to card user verification device 70 (and/or transaction device 62), and may further re-communicate the challenge code 38 from card user verification device 70 to card user identification device 94.

Card user identification device 94 represents any suitable components that communicate with card user verification device 70 in order to provide verification codes 114 to the verification entity device 14 to verify online transactions between card users and merchants. Card user identification device 94 may be a personal computer, a workstation, a laptop, a mobile telephone (such as a Smartphone, or any other wireless, cellular, cordless, or satellite telephone), an electronic notebook, a personal digital assistant, a transceiver node, a wired identification tag, a wireless identification tag, a radio frequency identification device, an audio-generation device, a smart card, any other device (wireless, wireline, or otherwise) capable of receiving, processing, storing, and/or communicating information with card user verification device 70 (and/or other components of system 10), or any combination of the preceding. Additionally, card user identification device 94 may include a user interface, such as a display, a microphone, keypad, a scanner (such as a QR code scanner), or other appropriate terminal equipment usable by the card user.

Card user identification device 94 may be carried by the card user (or otherwise associated with the card user). As such, when the card user attempts to conduct an online transaction with a merchant using payment card information (or the payment card), card user identification device 94 may communicate with card user verification device 70 (and verification entity device 14) in order to provide verification codes 114 that may allow the verification entity device 14 to verify the online transaction. Card user identification device 94 may be carried by the card user (or otherwise associated with the card user) in any suitable manner. For example, the card user identification device 94 may be a wireless identification tag that is attached to the card user's keys, wallet, purse, wearable items (such as a wearable wristband), and/or article of clothing (such as a belt). As another example, the card user identification device 94 may be a smart card that is carried within the card user's wallet, purse, or pocket. As a further example, the card user identification device 94 may be the card user's mobile phone.

As illustrated, card user identification device 94 includes a network interface 98, a processor 102, and a memory unit 106. Network interface 98 represents any suitable device operable to receive information from network 90, transmit information through network 90, perform processing of information, communicate to other devices, or any combination of the preceding. For example, network interface 98 receives a challenge code 38 from the verification entity device 14 (via the card user verification device 70) and communicates a verification code 114 to the verification entity device 14 (via the card user verification device 70). Network interface 98 represents any port or connection, real or virtual, including any suitable hardware and/or software, including protocol conversion and data processing capabilities, to communicate through a LAN, a MAN, a WAN, or other communication system that allows network interface 98 to exchange information with network 90, card user verification device 70, verification entity device 14, or other components of system 10. As an example, network interface 90 may be (or may further include) a radio frequency transceiver (such as a radio frequency identification transceiver, a Bluetooth transceiver, a WiFi transceiver, etc.) for communicating radio frequencies to and from the card user verification device 70. As another example, network interface 90 may be (or may further include) a speaker/microphone for communicating audio signals (such as audio tones) to and from card user verification device 70. As a further example, network interface 90 may be (or may further include) a card user display screen for capturing images (such as a QR code) generated and displayed on the card user verification device 70, or for generating and displaying images (such as a QR code) for capture by the card user verification device 70.

Processor 102 communicatively couples to network interface 98 and memory unit 106, and controls the operation and administration of card user identification device 94 by processing information received from network interface 98 and memory unit 106. Processor 102 includes any hardware and/or software that operates to control and process information. For example, processor 102 executes card user identification device management application 110 to control the operation of card user identification device 94. Processor 102 may be a programmable logic device, a microcontroller, a microprocessor, any suitable processing device, or any combination of the preceding.

Memory unit 106 stores, either permanently or temporarily, data, operational software, or other information for processor 102. Memory unit 106 includes any one or a combination of volatile or non-volatile local or remote devices suitable for storing information. For example, memory unit 106 may include RAM, ROM, magnetic storage devices, optical storage devices, any other suitable information storage device, or any combination of the preceding. Additionally, memory unit 106 may be an encrypted storage device (or a storage device secured in any suitable manner), providing protection against fraudulent attempts to access the information stored in memory unit 106. While illustrated as including particular information modules, memory unit 106 may include any suitable information for use in the operation of card user identification device 94.

As illustrated, memory unit 106 includes card user identification device management application 110, verification codes 114, and verification management application 46b. Card user identification device management application 110 represents any suitable set of instructions, logic, or code embodied in a computer-readable storage medium and operable to facilitate the operation of card user identification device 94. Verification codes 114 represent any code that may be used to identify the card user as the approved user of the payment card (as opposed to another person who may have fraudulently obtained the payment card). Examples of verification codes 114 are discussed in further detail below. Verification management application 46b may be substantially similar to verification management application 46a (stored in memory unit 34 of verification entity device 14). As such, verification management application 46b represents any suitable set of instructions, logic, or code embodied in a computer-readable storage medium and operable to provide a predefined manner of selecting verification codes 114. Verification management application 46b may be received by (and stored by) card user identification device 94 prior to card user identification device 94 receiving a challenge code 38. For example, verification management application 46b may be received by (and stored by) card user identification device 94 when card user identification device 94 is manufactured, programmed, and/or updated to operate with system 10. Furthermore, verification management application 46b may be received by (and stored by) card user identification device 94 at any other time. For example, verification management application 46b may be a portion of the challenge code 38 communicated for receipt by the card user identification device 94. In such an example, the card user identification device 94 may receive (and store) the verification management application 46b the first time it receives the challenge code 38 (or every time it receives the challenge code 38). As another example, verification management application 46b may be communicated to the card user identification device 94 in the same message as a challenge code 38, in a message prior to the communication of the challenge code 38, or in a message after the communication of the challenge code 38. As such, the card user identification device 94 may receive (and store) the verification management application 46b prior to receiving a challenge code 38, at the same time (or substantially the same time) as receiving a challenge code 38, or after receiving a challenge code 38. Examples of verification management application 46b are discussed in further detail below.

In an exemplary embodiment of operation, a card user may desire to conduct an online transaction with a particular merchant. For example, a card user may desire to purchase an item (such as a shirt) using a payment card (such as a credit card) and a transaction device 62 (such as the card user's laptop computer or mobile phone). In order to do so, the card user may access the merchant interface 66 associated with the merchant in order to select the item, and may provide the merchant with payment card information (via online payment 150). As a result of receiving the payment card information, the merchant device may begin processing the payment card information by providing an indication (via indication 154) to verification entity device 14 that the card user is attempting to perform an online transaction with the merchant using the payment card.

In order to protect against fraud, the verification entity (such as a credit card company or a clearinghouse that communicates with a credit card company) may desire to verify that the person attempting to perform the online transaction with the payment card is the card user that is authorized to use the payment card. For example, the credit card company may desire to verify that a card issued to John Doe is being used by John Doe, as opposed to someone that may have fraudulently obtained the card (or information about the card) issued to John Doe. To verify the identity of the person using the payment card, verification entity device 14 may communicate a challenge code 38 configured to interrogate a card user identification device 94 carried by (or otherwise associated with) the card user, such as a wireless identification tag attached to the keys of John Doe. The challenge code 38 may be first communicated to merchant device 54 (via first challenge message 158), which may then re-communicate the challenge code 38 to transaction device 62 (via second challenge message 162). The transaction device 62 may then re-communicate the challenge code 38 (via third challenge message 166) to a card user verification device 70, such as a wireless radio frequency identification transceiver connected to the USB port of the transaction device 62. Card user verification device 70 may receive the challenge code 38 and re-communicate the challenge code 38 to the card user identification device 94 (via fourth challenge message 170) carried by the card user, such as the wireless identification tag attached to the keys of John Doe. The challenge code 38 may interrogate the card user identification device 94, causing the card user identification device 94 to select a verification code 114 (via a predefined manner of verification management application 46b) and communicate (via first verification response message 174) the verification code 114 back to card user verification device 70. The card user verification device 70 may receive the verification code 114 and then re-communicate the verification code 114 to transaction device 62 (via second verification response message 178). The transaction device 62 may re-communicate the verification code 114 to merchant device 54 (via third verification response message 182), and the merchant device 54 may re-communicate the verification code 114 to verification entity device 14 (via fourth verification response message 186).

Following receipt of verification code 114, verification entity device 14 may select a comparison code 42 (via the predefined manner of verification management application 46a) to compare to the verification code 114 received from the card user identification device 94. If the verification code 114 does not match the comparison code 42 (or a verification code 114 is never received in response to a challenge code 38), verification entity device 14 may deny the processing of the online transaction. On the other hand, if the verification code 114 does match the comparison code 42, verification entity device 14 may verify the online transaction (or otherwise approve the processing of the online transaction) via verification signal 190 communicated to merchant device 54, and the online transaction may be allowed to occur. In particular embodiments, this method of verifying an online transaction may provide additional protection against fraud. For example, even if a person (or a device) is able to steal or copy a card user's payment card information (such as the payment card number, expiration date, and verification code) or the payment card (itself), the person may be unable to conduct one or more online transactions using the payment card information (or the payment card) because the person may not also have the card user identification device 94 (or the card user verification device 70). As another example, even if a person (or a device) is also able to attempt to respond to a challenge code 38 using a fraudulent device, the code provided by the fraudulent device may not match the comparison code 42 utilized by the verification entity device 14 because the fraudulent device may not have access to verification codes 114 or the verification management application 46b that results in a verification code 114 being selected in a predefined manner. Further details regarding particular examples of these sequences illustrated in FIG. 1 are discussed below.

As is stated above, a card user may initiate an online transaction with a merchant by providing payment card information to the merchant via online payment 150. Online payment 150 may be performed in any suitable manner. As an example, the card user may type (or otherwise enter) the payment card information into merchant interface 66, and then communicate the payment card information to the merchant device 54. As a further example, the payment card information may be automatically entered into merchant interface 54, such as when the payment card information is already saved (or otherwise on file with the merchant, the merchant device 54, the merchant interface 66, and/or the transaction device 62) for future online transactions. In such an example, once the payment card information is automatically entered, the card user may communicate the payment card information to the merchant device 54.

As a result of merchant device 54 receiving the payment card information, merchant device 54 may communicate indication 154 to verification entity device 14, indicating that that the card user is attempting to perform an online transaction with the merchant using the payment card. Indication 154 may include any information about the attempted online transaction. For example, indication 154 may include all (or a portion) of the payment card information received by the merchant device 54, information associated with the merchant (such as information that identifies the merchant), information associated with the online transaction (such as the purchase amount for the online transaction and details about what is being purchased), any other information desired by a verification entity for approving an online transaction, or any combination of the preceding.

Although indication 154 has been illustrated as being communicated directly from merchant device 54 to verification entity device 14, in particular embodiments, indication 154 may be communicated to one or more additional devices (not shown) before indication 154 is received by verification entity device 14. For example, indication 154 may first be communicated to a payment processor (such as a payment processing system run by, for example, First Data Merchant Services Corporation), and then the payment processor may re-communicate the indication 154 to verification entity device 14. The payment processor may re-communicate all or a portion of indication 154. Additionally, the payment processor may perform one or more payment processing actions (using the information in indication 154) prior to re-communicating indication 154. In such an example, the payment processor may add information associated with these additional payment processing actions to indication 154 prior to re-communicating indication 154 to verification entity device 14.

Following receipt of indication 154, verification entity device 14 may communicate a challenge code 38 (via first challenge message 158) for receipt by the card user identification device 94. As is discussed above, a challenge code 38 represents any code that may be used to interrogate card user identification device 94 for a verification code 114. For example, a challenge code 38 may be a computer-readable code that forces, requests, or causes a response from card user identification device 94. In such an example, the challenge code 38 may force, request, or cause the card user identification device 94 to select a verification code 114 stored at the card user identification device 94 and communicate the verification code 114 for receipt by the verification entity device 14.

A challenge code 38 may be the same code for all card user identification devices 94, or may be unique for each card user identification device 94 (or for one or more card user identification devices 94). For example, a challenge code 38 for a card user identification device 94 carried by John Doe may be different than a challenge code 38 for a card user identification device 94 carried by Jane Doe. Challenge code 38 may be the same challenge code every time it is sent for receipt by a particular card user identification device 94, or it may be different every time it is sent for receipt by a particular card user identification device 94. For example, challenge code 38 may include one or more details associated with the online transaction (such as the purchase amount, the merchant identification, the time and/or date associated with the online transaction or the challenge code 38, etc.), thereby causing it to be different every time it is sent for receipt by the card user identification device 94 carried by John Doe. As another example, the challenge code 38 may include a particular verification management application 46b for use by the card user identification device 94 for that online transaction. As a further example, the challenge code 38 may include particular instructions for responding to the challenge code 38 (such as a particular question that is to be answered using the verification code 114).

Following communication of challenge code 38 for receipt by a card user identification device 94, the challenge code 38 may be received by merchant device 54. Merchant device 54 may then re-communicate the challenge code 38 to transaction device 62 (via second challenge message 162), and transaction device 62 may re-communicate the challenge code 38 to card user verification device 70 (via third challenge message 166). Card user verification device 70 may act as an intermediary between verification entity device 14 and card user identification device 94. By doing so, card user verification device 70 may receive the challenge code 38 from verification entity device 14 (via first challenge message 158, second challenge message 162, and third challenge message 166) and re-communicate the challenge code 38 to card user identification device 94 (via fourth challenge message 170). Card user verification device 70 may re-communicate challenge code 38 in the same form (and/or in the same manner) in which card user verification device 70 received the challenge code 38. For example, card user verification device 70 may act as an amplifier (or an access point) that provides a network connection between verification entity device 14 and card user identification device 94. Additionally (or alternatively), card user verification device 70 may re-communicate challenge code 38 in a different form (and/or in a different manner) than what card user verification device 70 received the challenge code 38 as. For example, card user verification device 70 may receive the challenge code 38 in digital form over a wired connection and re-communicate the challenge code 38 in analog form over a wireless connection. As another example, card user verification device 70 may receive the challenge code 38 in digital form over a wireless connection and re-communicate the challenge code 38 in a radio frequency (or as a particular audio tone) over a different wireless connection. As a further example, card user verification device 70 may receive the challenge code 38 in a digital form over a wired connection and re-communicate the challenge code 38 as a graphical image (such as a barcode, a QR code, a universal product code (UPC), a matrix bar code, a MaxiCode, or a ShotCode) that may be scanned or copied by the card user identification device 94. In such examples, card user verification device 70 may act as a converter to convert challenge code 38 from a form (and/or a communication manner) that cannot be received by the card user identification device 94 to a form (and/or a communication manner) that can be received by the card user identification device 94.

Although challenge code 38 has been illustrated as being communicated from verification entity device 14 to card user verification device 70 (via various devices and messages) for re-communication to card user identification device 94, in particular embodiments, the challenge code 38 may be communicated directly from verification entity device 14 to the card user verification device 70 (for re-communication to card user identification device 94). For example, the card user verification device 70 may be a mobile phone that receives the challenge code 38 directly from the verification entity device 14. In such an example, the mobile phone may be running a mobile phone application associated with the verification entity device 14, and the verification entity device 14 may push the challenge code 38 directly to the mobile phone. Furthermore, the card user verification device 70 (such as a mobile phone) may be connected directly to the verification entity device 14 via a communication network, such as a network similar to network 50 (discussed above).

Additionally, although challenge code 38 has been illustrated as being communicated from verification entity device 14 to card user identification device 94 (via various devices and various messages), in particular embodiments, the challenge code 38 may be communicated directly from verification entity device 14 to the card user identification device 94. For example, the card user identification device 94 may be a mobile phone that receives the challenge code 38 directly. In such an example, the mobile phone may be running a mobile phone application associated with the verification entity device 14, and the verification entity device 14 may push the challenge code 38 directly to the mobile phone. Furthermore, the card user identification device 94 (such as a mobile phone) may be connected directly to the verification entity device 14 via a communication network, such as a network similar to network 50 (discussed above). In response to receiving the challenge code 38 directly from the verification entity device 14, the card user identification device 94 may communicate a verification code 114 to the card user verification device 70, which may then re-communicate the verification code 114 to the verification entity device 14 (either directly or via various devices and/or messages).

Furthermore, although challenge code 38 has been illustrated as being automatically re-communicated from the card user verification device 70 to the card user identification device 94, in particular embodiments, the re-communication (and/or even the original communication) of the challenge code 38 to the card user identification device 94 may only occur after a signal is first received from the card user identification device 94. For example, before the challenge code 38 may be received by the card user identification device 94 (and/or even communicated to the card user identification device 94), the card user may activate the card user identification device 94 (such as by pushing a button on the card user identification device 94 or performing any other user action with the card user identification device 94). This activation by the card user may cause the card user identification device 94 to send a signal to the card user verification device 70 (and/or the verification entity device 14) indicating that the card user identification device 94 is ready to receive the challenge code 38. Following receipt of this signal from the card user identification device 94, the challenge code 38 may be communicated to (and received by) the card user identification device 94.

Following receipt of the challenge code 38 by the card user identification device 94, the card user identification device 94 may (in response to the interrogation provided by the challenge code 38) select one of the verification codes 114 stored at the card user identification device 94. Furthermore, the card user identification device 94 may communicate the verification code 114 for receipt by the verification entity device 14. As is discussed above, a verification code 114 represents any code that may be used to identify the card user as the approved user of the payment card (as opposed to another person who may have fraudulently obtained the payment card information and/or the payment card). For example, a verification code 114 may be a predefined code stored at the card user identification device 94, and may be configured to match a comparison code 42 stored at the verification entity device 14. The verification code 114 may be a password, a set of numbers, a set of alphanumeric characters, a set of symbols, one or more audible tones, one or more radio frequencies, one or more graphical images, any other type of code or representation, or any combination of the preceding. The verification code 114 may have any length, size, or dimension. For example, the verification code 114 may be a 35 character password.

The verification code 114 may match a comparison code 42 when all or a portion of the verification code 114 is identical to all or a portion of the comparison code 42. For example, the verification code 114 may match the comparison code 42 when the last 30 digits of the verification code 114 are identical to the last 30 digits of the comparison code 42. Additionally (or alternatively), the verification code 114 may match a comparison code 42 when the verification code 114 is an answer to the comparison code 42 (such as an answer to a question), when the verification code 114 completes the comparison code 42 (such as a final piece of a puzzle), when the verification code 114 is the opposite of the comparison code 42 (such as the term “up” is the opposite of “down”), any other manner of matching, or any combination of the preceding.

Card user identification device 94 may store any suitable number of different verification codes 114. For example, card user identification device 94 may store 2 different verification codes 114, 5 different verification codes 114, 10 different verification codes 114, 15 different verification codes 114, 25 different verification codes 114, 50 different verification codes 114, 100 different verification codes 114, 1,000 different verification codes 114, 10,000 different verification codes 114, 1 million different verification codes 114, or any other number of different verification codes 114. Furthermore, following receipt of the challenge code 38 by the card user identification device 94, the card user identification device 94 may select one of the verification codes 114 stored at the card user identification device 94. The card user identification device 94 may select one of the verification codes 114 according to a predefined manner based on verification management application 46b. For example, card user identification device 94 may select one of the verification codes 114 by sequentially rotating through each of the verification codes 114 (e.g., rotating from a first code to a second code), by skipping over a predefined number of the verification codes 114 (e.g., skipping from the first code to the fifth code), by selecting a position of one of the verification codes 114 (e.g., selecting the code positioned in column five, row ten), any other manner of selecting one of the verification codes 114 according to a predefined manner based on verification management application 46b, or any combination of the preceding. Furthermore, selection of the verification code 114 may further include modifying the verification code 114. For example, the verification code 114 may be modified to include information from the challenge code 38, such as all or a portion of the challenge code 38, or details associated with the online transaction (e.g., the purchase amount, the merchant identification, the date and/or time associated with the online transaction or the challenge code 38, etc.). As another example, the verification code 114 may be modified to include information regarding the date and/or time associated with the selection of the verification code 114. Further details regarding examples of the selection of a verification code 114 are discussed below with regard to FIG. 2.

Following the selection of the verification code 114, the card user identification device 94 may communicate the verification code 114 to the card user verification device 70 via first verification response message 174. The card user identification device 94 may communicate the verification code 114 to the card user verification device 70 in any suitable manner (and/or any suitable form). As an example, the card user identification device 94 may communicate the verification code 114 to the card user verification device 70 in the same manner of communication (and/or form) by which the card user identification device 94 received the challenge code 38. In such an example, if the card user identification device 94 received the challenge code 38 in a particular radio frequency, the card user identification device 94 may communicate the verification code 114 to the card user verification device 70 in the same radio frequency. As another example, the card user identification device 94 may communicate the verification code 114 to the card user verification device 70 in a different manner of communication (and/or form) than that by which the card user identification device 94 received the challenge code 38. In such an example, if the card user identification device 94 received the challenge code 38 as a particular audio tone, the card user identification device 94 may communicate the verification code 114 to the card user verification device 70 in a different audio tone, a radio frequency, a graphical image displayed or sent to the card user verification device 70, any other manner (and/or form) different from that by which the card user identification device 94 received the challenge code 38, or any combination of the preceding.

Furthermore, the selection and communication processes of the verification code 114 by the card user identification device 94 may occur without user intervention. For example, following the reception of the challenge code 38 by the card user identification device 94, the card user identification device 94 may both automatically select and communicate the verification code 114 without any intervention by the card user (e.g., without the card user pressing a button, confirming a selection, pointing the card user identification device 94 in a particular direction, scanning the card user identification device 94, etc.). As such, verifying the online transaction using the card user identification device 94 may occur without any action by the user, other than the card user actually carrying the card user identification device 94 with them when performing the online transaction (such as carrying the card user identification device 94 in the card user's purse or attached to the card user's keys) and/or other than the card user performing the online transaction with a transaction device 62 (and/or card user verification device 70) that is within communication range to the card user identification device 94 (such as within Bluetooth range, WiFi range, radio frequency identification range, infrared range, or any other suitable range). Alternatively, one or more (or both) of the selection and communication processes of the verification code 114 by the card user identification device 94 may occur with user intervention. For example, selection of the verification code 114 may occur when the card user presses a button on the card user identification device 94 to select the verification code 114, when the card user points the card user identification device 94 at the card user verification device 70 (or hovers the card user identification device 94 over a scanner at the card user verification device 70), when the card user performs any other manner of user intervention, or any combination of the preceding. As another example, communication of the verification code 114 may occur when the card user points the card user identification device 94 at the card user verification device 70 (or hovers the card user identification device 94 over a scanner at the card user verification device 70), when the card user swipes the card user identification device 94 (such as a smart card) through a card reader on the card user verification device 70, when the card user presses a button to communicate the verification code 114, any other manner of user intervention, or any combination of the preceding.

Following receipt of the verification code 114 by card user verification device 70, the card user verification device 70 may re-communicate the verification code 114 for receipt by the verification entity device 14 via second verification response message 174. Card user verification device 70 may re-communicate the verification code 114 in the same form (and/or communication manner) in which card user verification device 70 received the verification code 114. Furthermore (or alternatively), card user verification device 70 may re-communicate the verification code 114 in a different form (and/or manner) than by which the card user verification device 70 received the verification code 114. For example, if the card user verification device 70 received the verification code 114 via a wireless radio frequency, the card user verification device 70 may re-communicate the verification code 114 to the verification entity device 14 via a wired internet connection. In such an example, card user verification device 70 may act as a converter to convert verification code 114 from a form (and/or communication manner) that cannot be received by the verification entity device 14 to a form (or communication manner) that can be received by the verification entity device 14. Following re-communication of the verification code 114 from card user verification device 70 (via second verification response message 174), transaction device 62 may receive the verification code 114, and re-communicate the verification code 114 to merchant device 54 (via third verification response message 182). Furthermore, merchant device 54 may then re-communicate the verification code 114 to the verification entity device 14 (via fourth verification response message 186).

Following receipt of the verification code 114 by the verification entity device 14, the verification entity device 14 may select one of the comparison codes 42 stored at the verification entity device 14 for comparison with the verification code 114. As is discussed above, a comparison code 42 represents any code that may be compared to a verification code 114 in order to verify an online transaction. For example, a comparison code 42 may be predefined code stored at the verification entity device 14 and that is configured to match a verification code 114 stored at the card user identification device 94. Similar to the verification code 114, the comparison code 42 may be a password, a set of numbers, a set of alphanumeric characters, a set of symbols, one or more audible tones, one or more radio frequencies, one or more graphical images, any other type of code or representation, or any combination of the preceding. The comparison code 42 may have any length, size, or dimension. For example, the comparison code 42 may be a 35 character password. The comparison code 42 may match a verification code 114 when all or a portion of the comparison code 42 is identical to all or a portion of the verification code 114. Additionally, the comparison code 42 may match a verification code 114 in any of the manners of matching discussed above with regard to verification codes 114.

Verification entity device 14 may store (for each account 34) any suitable number of different comparison codes 42. For example, verification entity device 14 may store (for each account 34) 2 different comparison codes 42, 5 different comparison codes 42, 10 different comparison codes 42, 15 different comparison codes 42, 25 different comparison codes 42, 50 different comparison codes 42, 100 different comparison codes 42, 1,000 different comparison codes 42, 10,000 different comparison codes 42, 1 million different comparison codes 42, or any other number of different comparison codes 42. As another example, verification entity device 14 may store (for each account 34) a matching comparison code 42 for each verification code 114 stored by the card user identification device 94 (and associated with an account 34). In such an example, if the card user identification device 94 stores 10 different verification codes 114, the verification entity device 14 may store 10 matching comparison codes 42.

The verification entity device 14 may select one of the comparison codes 42 according to the same predefined manner utilized by the card user identification device 94. For example, if the card user identification device 94 selects one of the verification codes 114 by sequentially rotating through each of the verification codes 114 (e.g., rotating from a first code to a second code), the verification entity device 14 may select one of the comparison codes 42 by sequentially rotating through each of the comparison codes 42 (e.g., rotating from a first code to a second code). As such, both the card user identification device 94 and the verification entity device 14 may utilize the same predefined manner (based on verification management applications 46b and 46a, respectively) to select a matching verification code 114 and comparison code 42. Furthermore, selection of the comparison code 42 may further include modifying comparison code 42. For example, the comparison code 42 may be modified to include information from the challenge code 38, such as all or a portion of the challenge code 38, or details associated with the online transaction (e.g., the purchase amount, the merchant identification, the time and/or date associated with the online transaction or the challenge code 38, etc.). As another example, the comparison code 42 may be modified to include information regarding the date and/or time associated with the reception of the verification code 114. Further details regarding examples of the selection of a comparison code 42 are discussed below with regard to FIG. 2.

Although the verification entity device 14 has been discussed above as selecting one of the comparison codes 42 according to the same predefined manner utilized by the card user identification device 94, in particular embodiments, the verification entity device 14 may select one of the comparison codes 42 in a different predefined manner than the card user identification device 94 (but in a manner that still causes the selected comparison code 42 to match the selected verification code 114). For example, the verification entity device 14 may store the comparison codes 42 in a different order than the card user identification device 94 stores the matching verification codes 114. In such an example, the verification entity device 14 may select the comparison code 42 using a first predefined manner (such as by sequentially rotating through each of the comparison codes 42, for example) while the card user identification device 94 may select the matching verification code 114 using a second predefined manner (such as by skipping over a predefined number of the verification codes 114, for example). Furthermore, although selection of the comparison code 42 has been discussed above as occurring after reception of the verification code 114, the comparison code 42 may be selected any time after indication 154 is received by the verification entity device 14. For example, the comparison code 42 may be selected before the challenge code 38 is communicated for receipt by the card user identification device 94. As another example, the comparison code 42 may be selected after the challenge code 38 is communicated for receipt by the card user identification device 94, but before the verification entity device 14 receives the verification code 114.

Following receipt of the verification code 114 by the verification entity device 14 and further following selection of the comparison code 42 by the verification entity device 14, the verification entity device 14 may compare the verification code 114 to the comparison code 42 in order to determine whether the verification code 114 matches the comparison code 42. If the verification code 114 does not match the comparison code 42 (or a verification code 114 is never received in response to a challenge code 38), verification entity device 14 may deny the online transaction. This denial may result in a denial message (not shown) being sent to merchant device 54, transaction device 62, card user verification device 70, and/or card user identification device 94. As a result, the online transaction will not be allowed to occur. On the other hand, if the verification code 114 does match the comparison code 42, verification entity device 14 may verify the online transaction (or otherwise approve the processing of the online transaction) by communicating a verification signal 190 to merchant device 54 (and/or one or more of transaction device 62, card user verification device 70, and card user identification device 94). As such, the online transaction may be allowed to occur.

Although verification entity device 14 has been illustrated as comparing a single verification code 114 to a single comparison code 42 in order to verify a particular online transaction, in particular embodiments, verification entity device 14 may compare more than one verification code 114 to more than one comparison code 42 in order to verify the particular online transaction. For example, for each online transaction, two or more verification codes 114 and two or more comparison codes 42 may be selected for the verification process. In such an example, verification entity device 14 may only verify (or otherwise allow) the online transaction if each of the selected verification codes 114 match each of the selected comparison codes 42.

Furthermore, although verification entity device 14 has been illustrated as verifying (or otherwise approving) the online transaction if the verification code 114 matches the comparison code 42, in particular embodiments, verification (or approval) of the online transaction may include various additional steps. For example, verification entity device 14 may determine whether the payment card has been reported lost or stolen, whether the online transaction appears suspicious based on the card user's typical purchases, whether there is a sufficient balance associated with the payment card to approve the online transaction, whether the online transaction will cause a credit limit associated with the payment card (or account 34) to be overdrawn, whether a billing address listed in the payment card information received from the card user matches the billing address listed in account 34 for the card user, any other suitable method for determining whether to verify (or approve) the online transaction, or any combination of the preceding.

Additionally, although verification entity device 14 has been illustrated as storing and communicating challenge codes 38, storing and selecting comparison codes 42, and verifying the online transactions by comparing comparison codes 42 to verification codes 114, in particular embodiments, one or more (or all) of these actions may be performed by other devices or components of system 10, such as card user verification device 74, transaction device 62, merchant device 54, and/or one or more third party devices or components. For example, card user verification device 70 may store and communicate challenge codes 38, store and select comparison codes 42, and verify the online transactions by comparing comparison codes 42 to verification codes 114. In such an example, verification entity device 14 may approve the online transaction (or otherwise allow the online transaction to occur) if the card user verification device 70 verifies the online transaction and communicates a verification signal (such as verification signal 190) to the verification entity device 14. As another example, merchant device 54 and/or the transaction device 62 (using merchant interface 66) may store and communicate challenge codes 38 for receipt by the card user identification device 94. In such an example, the transaction device 62 may include a plug in application installed on a web browser, and the plug in application may communicate a challenge code 38 for receipt by the card user identification device 94 after the payment card information has been entered into merchant interface 66).

In particular embodiments, the above-described method of verifying an online transaction may provide additional protection against fraud. For example, even if a person (or a device) is able to steal or copy a card user's payment card information (such as the payment card number, expiration date, and verification code) or the payment card (itself), the person may be unable to conduct one or more online transactions using the payment card information (or the payment card) because the person may not also have the card user identification device 94 (or the card user verification device 70). As another example, even if a person (or a device) is also able to attempt to respond to a challenge code 38 using a fraudulent device, the code provided by the fraudulent device may not match the comparison code 42 utilized by the verification entity device 14 because the fraudulent device may not have access to verification codes 114 or the verification management application 46b that results in a verification code 114 being selected in a predefined manner.

Modifications, additions, or omissions may be made to system 10 without departing from the scope of the invention. For example, verification entity device 14 may verify any number of online transactions that are performed using any number of merchant devices 54, card user environments 58, transaction devices 62, card user verification devices 70, card user identification devices 94, card users, and/or merchants. Additionally, system 10 may include any number of verification entity devices 14, networks 50, merchant devices 54, card user environments 58, transaction devices 62, card user verification devices 70, networks 90, and/or card user identification devices 94 (and/or any number of components, such as processors or memory units illustrated in the above described devices). Also, any suitable logic may perform the functions of system 10 and the components and/or devices within system 10. Furthermore, one or more components of system 10 may be combined. For example, transaction device 62 may be a virtual processing system that utilizes a portion of merchant device 54 (and/or the processing capability of merchant device 54) to perform (or attempt to perform) an online transaction.

Additionally, system 10 may include additional components. For example, as is discussed above, a payment processor (such as a payment processing system run by, for example, First Data Merchant Services Corporation) may be communicatively located in-between the merchant device 54 and the verification entity device 14. In such an example, all or a portion of one or more communications between merchant device 54 and verification entity device 14 may be communicated through (and/or modified by) the payment processor. As another example, system 10 may further include one or more additional secured devices (such as additional secured servers) that receive all or a portion of the payment card information communicated by the card user when performing (or attempting to perform) the online transaction. In such an example, the payment card information entered by the card user may not be communicated to the merchant device 54, but instead may be communicated to an additional secured server that is associated with the merchant. As such, the payment card information may be even further protected from fraudulent attempts to access it.

Furthermore, one or more of the communications (such as all of the communications) between one or more components of system 10 (such as verification entity device 14, network 50, merchant device 54, card user environment 58, transaction device 62, card user verification device 70, network 90, and/or card user identification device 94) may be encrypted (or otherwise secured in any suitable manner), providing protection against fraudulent attempts to access the information included in the communications. Additionally, one or more of the communications (such as all of the communications) between one or more components of system 10 (such as verification entity device 14, network 50, merchant device 54, card user environment 58, transaction device 62, card user verification device 70, network 90, and/or card user identification device 94) may further include one or more codes that may assist in identifying the communication as being sent by one of the devices or components of system 10. For example, the card user verification device 70 may generate a random code, and insert the code into any communication with the card user identification device 94. Based on this random code, card user identification device 94 may be able to identify the communication as having been sent by the card user verification device 70, and thus the card user identification device 94 may respond to the communication. In such an example, the card user identification device 94 may also generate a random code, and insert the code into any communication with the card user verification device 70. Based on this random code, card user verification device 70 may be able to identify the communication as having been sent by the card user identification device 94, and thus the card user verification device 70 may re-communicate the communication for receipt by the verification entity device 14.

FIG. 2 illustrates an example selection 200 of verification codes 114 and comparison codes 42. Verification codes 114 are selected by the card user identification device 94 of FIG. 1, and comparison codes 42 are selected by the verification entity device 14 of FIG. 1, for example. Furthermore, following selection (and communication) of verification codes 114 and comparison codes 42, verification entity device 14 may compare verification codes 114 to comparison codes 42 in order to determine whether to allow an online transaction to occur, as is discussed above.

Verification codes 114 and comparison codes 42 may each be selected according to a predefined manner based on verification management applications 46. For example, verification codes 114 and comparison codes 42 may be selected by sequentially rotating through each of the verification codes 114 and comparison codes 42 (e.g., rotating from a first code to a second code), by skipping over a predefined number of the verification codes 114 and comparison codes 42 (e.g., skipping from the first code to the fifth code), by selecting a position of one of the verification codes 114 and comparison codes 42 (e.g., selecting the code positioned in column five, row ten), any other manner of selecting one of the verification codes 114 and one of the comparison codes 42 according to a predefined manner based on verification management applications 46, or any combination of the preceding.

As illustrated, verification codes 114 and comparison codes 42 may each be selected by sequentially rotating through each of the verification codes 114 and comparison codes 42. For example, the card user identification device 94 may store the following verification codes 114: Code A, Code B, Code C, Code D, . . . Code n. Furthermore, the verification entity device 14 may store the following comparison codes 42, each of which match a respective verification code 114: Code A, Code B, Code C, Code D, . . . Code n.

In one example of the operation of selection 200, when a card user attempts to perform a first potential online transaction using a payment card (such as when a card user attempts to purchase a shirt from merchant A), the predefined manner (based on verification management application 46b) may cause the card user identification device 94 to select Code A as the verification code 114 for communication to the verification entity device 14. Furthermore, the same predefined manner (based on verification management application 46a) may cause the verification entity device 14 to select the matching Code A as the comparison code 42. As such, the verification code 114 (i.e., Code A) will match comparison code 42 (i.e., Code A), and the first online transaction will be allowed to proceed.

For the second potential online transaction of the card user (such as when the card user attempts to purchase shoes from merchant B), the predefined manner (based on verification management application 46b) may cause the card user identification device 94 to sequentially rotate to and select Code B as the verification code 114 for communication to the verification entity device 14. That is, the sequential rotation may cause the card user identification device 94 to rotate to and select the next verification code 114 (i.e., Code B) in the sequence of verification codes 114. Furthermore, the same predefined manner (based on verification management application 46a) may cause the verification entity device 14 to sequentially rotate to and select the matching Code B as the comparison code 42. As such, the verification code 114 (i.e., Code B) will match the comparison code 42 (i.e., Code B), and the second online transaction will be allowed to proceed.

This sequential rotation through (and selection of) the verification codes 114 and comparison codes 42 may continue until Code n is selected for both the verification code 114 and the comparison code 42. After Code n is selected, the process of selecting verification codes 114 and comparison codes 42 may be reset (as is seen by resets 204a and 204b) back to Code A. Therefore, for the next potential online transaction of the card user (such as when the card user attempts to pay for a hair cut from merchant O), the predefined manner (based on verification management application 46b) may cause the card user identification device 94 to sequentially rotate to (via reset 204a) and re-select Code A as the verification code 114 for communication to the verification entity device 14. Furthermore, the same predefined manner (based on verification management application 46a) may cause the verification entity device 14 to sequentially rotate to (via reset 204b) and re-select the matching Code A as the comparison code 42. As such, the verification code 114 (i.e., Code A) will match the comparison code 42 (i.e., Code A), and the next online transaction will be allowed to proceed.

Based on the sequential rotation through verification codes 114 and comparison codes 42, the verification codes 114 and comparison codes 42 may be rotated through continuously. This may allow the same code to be re-used as the verification code 114 and comparison code 42 at a later date and/or time from the original use of the code. As such, the card user identification device 94 may not need to receive new verification codes 114 from verification entity device 14 (or some other device associated with the verification entity) when all of the verification codes 114 have already been used.

Modifications, additions, or omissions may be made to selection 200 without departing from the scope of the invention. For example, although selection 200 illustrates a sequential rotation for selecting verification codes 114 and comparison codes 42, any other manner of selecting one of the verification codes 114 and one of the comparison codes 42 may be utilized (such as a reverse sequential rotation where the rotation process rotates from Code B to Code A; skipping over a predefined number of the verification codes 114 and comparison codes 42; selecting a position of one of the verification codes 114 and comparison codes 42; or any combination of the preceding). Additionally, selection 200 may be performed using any number of verification codes 114 and comparison codes 42.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth in this specification. Such embodiments may be obtained, for example, by combining, modifying, or reorganizing any of the disclosed steps, components, elements, features, aspects, characteristics, limitations, and the like, of the various non-limiting and non-exhaustive embodiments described in this specification. In this manner, Applicant reserves the right to amend the claims during prosecution to add features as variously described in this specification, and such amendments comply with the requirements of 35 U.S.C. §§112(a) and 132(a).

1. An online transaction verification system, comprising:
one or more memory units configured to:
store one or more instructions; and
store a plurality of comparison codes; and
one or more processors coupled to the memory units and configured, upon executing the one or more instructions, to:
receive an indication that a card user is attempting to perform an online transaction using payment card information and a transaction device, the transaction device being communicatively coupled to a merchant device with which the card user is attempting to perform the online transaction;
following reception of the indication, transmit a challenge code configured to interrogate a card user identification device for a first verification code, wherein the challenge code is received by a card user verification device communicatively coupled to the transaction device, wherein the challenge code is re-transmitted from the card user verification device to the card user identification device;
following transmittal of the challenge code, receive the first verification code from the card user identification device, wherein the first verification code is selected, by the card user identification device, from a plurality of verification codes stored by the card user identification device, wherein the first verification code is selected, by the card user identification device, according to a first manner of selection;
select a first comparison code from the plurality of comparison codes according to the first manner of selection;
compare the first comparison code to the first verification code from the card user identification device; and
following a determination that the first comparison code matches the first verification code, transmit a verification signal configured to indicate that the online transaction has been verified.

2. The online transaction verification system of claim 1, wherein:
in accordance with the first manner of selection, the one or more processors are further configured to sequentially rotate through the plurality of comparison codes in order to select the first comparison code; and
in accordance with the first manner of selection, the first verification code is selected, by the card user identification device, by sequentially rotating through the plurality of verification codes.

3. The online transaction verification system of claim 2, wherein:
in accordance with the first manner of selection, the one or more processors are further configured to re-select the first comparison code for use in verifying a subsequent transaction after each of the other comparison codes have been sequentially rotated to and selected; and
in accordance with the first manner of selection, the first verification code is re-selected, by the card user identification device, for use in verifying the subsequent transaction after each of the other verification codes have been sequentially rotated to and selected.

4. The online transaction verification system of claim 1, wherein the card user verification device is physically coupled to a universal serial bus (USB) connector associated with the transaction device.

5. The online transaction verification system of claim 1, wherein the card user identification device is communicatively coupled to the card user verification device by one of the following:
a wired communication network;
a wireless communication network;
a radio frequency identification communication network; or
an infrared communication network.

6. The online transaction verification system of claim 1, wherein the card user identification device comprises one of the following:
a wireless identification tag;
a wired identification tag;
a mobile telephone;
a radio frequency identification device;
an audio-generation device; or
a smart card.

7. The online transaction verification system of claim 1, wherein the card user verification device comprises a mobile telephone.

8. A non-transitory computer readable medium comprising logic configured, when executed by one or more processors, to:
store a plurality of comparison codes; and
receive an indication that a card user is attempting to perform an online transaction using payment card information and a transaction device, the transaction device being communicatively coupled to a merchant device with which the card user is attempting to perform the online transaction;
following reception of the indication, transmit a challenge code configured to interrogate a card user identification device for a first verification code, wherein the challenge code is received by a card user verification device communicatively coupled to the transaction device, wherein the challenge code is re-transmitted from the card user verification device to the card user identification device;
following transmittal of the challenge code, receive the first verification code from the card user identification device, wherein the first verification code is selected, by the card user identification device, from a plurality of verification codes stored by the card user identification device, wherein the first verification code is selected, by the card user identification device, according to a first manner of selection;
select a first comparison code from the plurality of comparison codes according to the first manner of selection;
compare the first comparison code to the first verification code from the card user identification device; and
following a determination that the first comparison code matches the first verification code, transmit a verification signal configured to indicate that the online transaction has been verified.

9. The non-transitory computer readable medium of claim 8, wherein:
in accordance with the first manner of selection, the logic is further configured to sequentially rotate through the plurality of comparison codes in order to select the first comparison code; and
in accordance with the first manner of selection, the first verification code is selected, by the card user identification device, by sequentially rotating through the plurality of verification codes.

10. The non-transitory computer readable medium of claim 9, wherein:
in accordance with the first manner of selection, the logic is further configured to re-select the first comparison code for use in verifying a subsequent transaction after each of the other comparison codes have been sequentially rotated to and selected; and
in accordance with the first manner of selection, the first verification code is re-selected, by the card user identification device, for use in verifying the subsequent transaction after each of the other verification codes have been sequentially rotated to and selected.

11. The non-transitory computer readable medium of claim 8, wherein the card user verification device is physically coupled to a universal serial bus (USB) connector associated with the transaction device.

12. The non-transitory computer readable medium of claim 8, wherein the card user identification device comprises one of the following:
a wireless identification tag;
a wired identification tag;
a mobile telephone;
a radio frequency identification device;
an audio-generation device; or
a smart card.

13. The non-transitory computer readable medium of claim 8, wherein the card user verification device comprises a mobile telephone.

14. A method, comprising:
storing, by one or more processors, a plurality of comparison codes;
receiving, by the one or more processors, an indication that a card user is attempting to perform an online transaction using payment card information and a transaction device, the transaction device being communicatively coupled to a merchant device with which the card user is attempting to perform the online transaction;
following reception of the indication, transmitting, by the one or more processors, a challenge code configured to interrogate a card user identification device for a first verification code, wherein the challenge code is received by a card user verification device communicatively coupled to the transaction device, wherein the challenge code is re-transmitted from the card user verification device to the card user identification device;
following transmittal of the challenge code, receiving, by the one or more processors, the first verification code from the card user identification device, wherein the first verification code is selected, by the card user identification device, from a plurality of verification codes stored by the card user identification device, wherein the first verification code is selected, by the card user identification device, according to a first manner of selection;
selecting, by the one or more processors, a first comparison code from the plurality of comparison codes according to the first manner of selection;
comparing, by the one or more processors, the first comparison code to the first verification code from the card user identification device; and
following a determination that the first comparison code matches the first verification code, transmitting, by the one or more processors, a verification signal configured to indicate that the online transaction has been verified.

15. The method of claim 14, wherein:
in accordance with the first manner of selection, the first comparison code is selected, by the one or more processors, by sequentially rotating through the plurality of comparison codes; and
in accordance with the first manner of selection, the first verification code is selected, by the card user identification device, by sequentially rotating through the plurality of verification codes.

16. The method of claim 15, further comprising, in accordance with the first manner of selection, re-selecting, by the one or more processors, the first comparison code for use in verifying a subsequent transaction after each of the other comparison codes have been sequentially rotated to and selected, wherein, in accordance with the first manner of selection, the first verification code is re-selected, by the card user identification device, for use in verifying the subsequent transaction after each of the other verification codes have been sequentially rotated to and selected.

17. The method of claim 14, wherein the card user verification device is physically coupled to a universal serial bus (USB) connector associated with the transaction device.

18. The method of claim 14, wherein the card user identification device is communicatively coupled to the card user verification device by one of the following:
a wired communication network;
a wireless communication network;
a radio frequency identification communication network; or
an infrared communication network.

19. The method of claim 14, wherein the card user identification device comprises one of the following:
a wireless identification tag;
a wired identification tag;
a mobile telephone;
a radio frequency identification device;
an audio-generation device; or
a smart card.

20. The method of claim 14, wherein the card user verification device comprises a mobile telephone.
